(19) United States
(12) Patent Application Publication
(10) Pub. No.: US 2010/0182486 A1
(43) Pub. Date: Jul. 22, 2010

(54) Portable Image Acquisitioner with Micro Objective Lens

(76) Inventor: Backer Chou, Taipei County (TW)

Correspondence Address: SHOU - HSIN YIN, P.O. BOX 90-3 Taipei, TAIPEI City, 10699, TW

(21) Appl. No.: 12/355,809

(22) Filed: Jan. 19, 2009

(51) Int. Cl. H04N 5/225; G03B 13/32

(52) U.S. Cl. 348/345; 348/376

(57) ABSTRACT

A portable image acquisitioner with micro objective lens for photographing or observing with hand-holding is disclosed. The image acquisitioner includes a V-shaped foldable body and a rotatable lens. The body is composed of a first casing and a second casing pivotedly connected thereto. There is a display on the first casing for instantly showing a shot image. An outer end of the first casing is provided with a longitudinally rotatable rotor. The lens is pivotedly fixed at an outer end of the rotor for transversely rotating. The lens can be adjusted to a required angle by longitudinal and transverse rotation. When the body is opened in V-shape, the second casing can be as a seat for placing on a table. An object can be put on the second casing for being shot by the lens.

### BACKGROUND OF THE INVENTION

1. Field of the Invention

The invention relates to handheld electronic devices, more particularly to handheld image acquisitioners with micro objective lens.

2. Related Art

Taiwan Patent No. M328019 discloses an image acquisitioner having an image sensor therein. By rotating the adjusting wheel to focus, an object can be shot or observed by an objective lens in a close-up distance. However, an outline of the image acquisitioner disclosed is a cuboid. Signals from the image sensor are sent to a display or memory for showing or storing via a signal wire.

However, such a type of image acquisitioner must cooperate with some external devices such as computers or displays for obtaining power supply and for showing images. Thus, conventional image acquisitioners are very inconvenient and limited for users. They can not be portable or be used outdoors. The usability of outdoor teaching for schools, nature observation for children and operating anywhere is impossible. Accordingly, applications and functions of conventional image acquisitioners are limited.

For this reason, the inventor tried to combine a micro objective lens and a body under a concept of digital cameras or camcorders. However, an angle between the lens and the body must be unvarying. To change the angle of the lens, the user must adjust position of the body. Although it is satisfied enough for generally active or static portrait or environmental photography, it is unsatisfied for close-up photography. When performing close-up photography, the lens must match up with position or direction of the object (its viewing angle is different from human eyes.). In some cases, the object to be shot is living; or in other cases, the object to be shot is in motion. There are too many unexpectable variations and adjustments of use mode. Conventional image acquisitioners with unvarying angle between the lens and body can not satisfy requirements of users.

### SUMMARY OF THE INVENTION

A primary object of the invention is to provide an image acquisitioner with micro objective lens, whose lens can be rotated on a body within a large range. The micro objective lens is rotatably connected to the body with 2 pivots. The angle between the lens and body can be adjusted into a specific position, so that a user can hold the body in a comfort gesture for observation or photography.

Another object of the invention is to provide an image acquisitioner with micro objective lens, whose body is foldable in V-shape. Besides being held, the body can be put on a table to stand alone. The casing laid down on the table can be as an object carrier for carrying the object to be shot.

To accomplish the abovementioned objections, the portable image acquisitioner with micro objective lens includes a V-shaped foldable body and a rotatable lens. The body is composed of a first casing and a second casing pivotedly connected thereto. There is a display on the first casing for instantly showing a shot image. An outer end of the first casing is provided with a longitudinally rotary rotor. The lens is pivotedly fixed at an outer end of the rotor for transversely rotating. The lens can be adjusted to a required angle by longitudinal and transverse rotation. When the body is opened in V-shape, the second casing can be as a seat for placing on a table. An object can be put on the second casing for being shot by the lens.

### BRIEF DESCRIPTION OF THE DRAWINGS

FIG. 1 is a perspective view of the invention in a first status;

FIG. 2 is a perspective view of the invention in a second status;

FIG. 3 is a perspective view of the invention in a third status;

FIG. 4 is an exploded view of the second casing of the invention;

FIGS. 5-7 show the lens turned to different angles when the body is opened in V-shape;

FIG. 8 shows the body opened in 90 degree; and

FIG. 9 shows the body parallelly folded up.

### DETAILED DESCRIPTION OF THE INVENTION

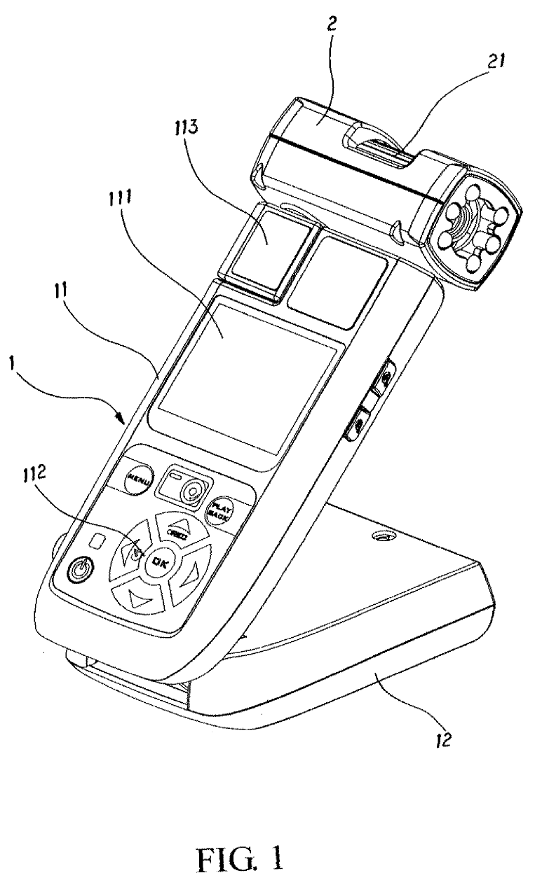

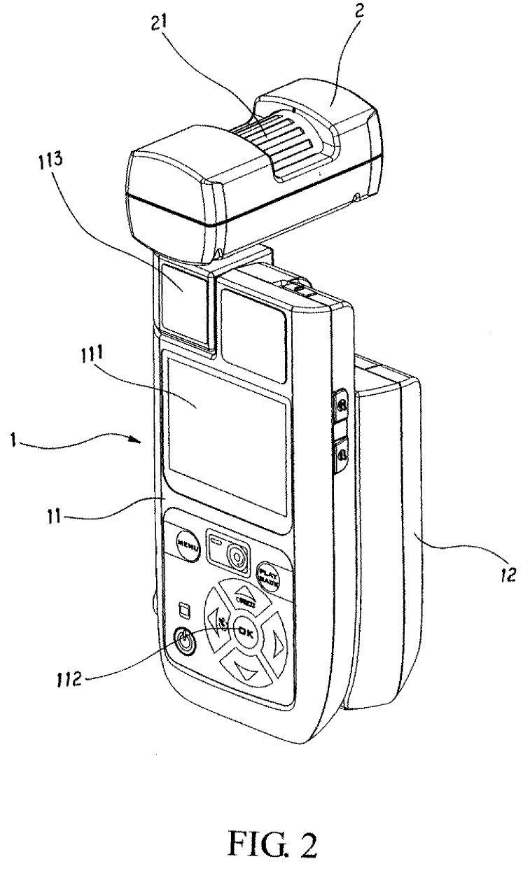

Referring to FIG. 1, a preferred embodiment according to the invention includes a body and a micro objective lens 2. The body 1 is composed of a first casing 11 and a second casing 12 pivotedly connected thereto. The two casings 11 and 12 are V-shaped foldable, which can be parallelly folded up for being handheld by a user as shown in FIG. 2, or opened in V-shape as shown in FIG. 1. There is a display 111 and a ksypad 112 on a surface of the first casing 11. The display 111 can show images shot by the lens 2. The keypad 112 can provide necessary operation for users, such as accessing images or scrolling up or down.

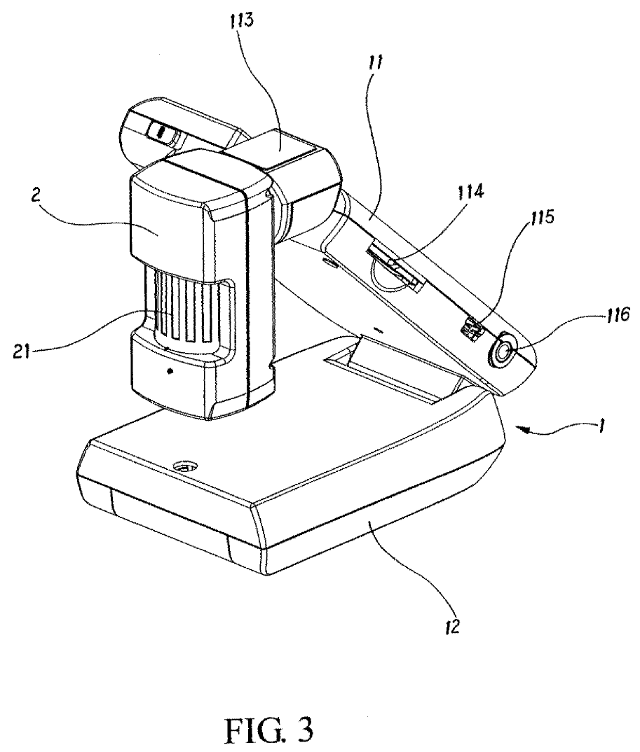

An outer end of the first casing 11, which is not the end connecting to the second casing 12, is provided with a rotor 113 which can longitudinally rotate along the direction of the body 1. As shown in FIG. 3, a rotating range of the rotor 113 is approximately from plus 60 degree to minus 60 degree. The lens 2 is a long cuboid having an adjusting wheel 21 for focusing. The length of lens 2 is approximately the same as the width of body 1. The lens 2 is pivotedly connected to an outer end of the rotor 113 so that the lens 2 can transversely rotate in opposition to the rotor 113 as shown in FIGS. 2 and 3. A rotating range of the lens 2 is approximately 180 degree. In other words, the lens 2 can turn over in horizontal direction. By both longitudinal rotation of the rotor 113 and transverse rotation of the lens 2, the angle between the body 1 and lens 2 can be adjusted in a large range. As can be seen in FIG. 2, the body 1 is suitable for being handheld by a user when the first casing 11 and the second casing 12 are parallelly folded up. The lens 2 can be rotated to a required angle by rotating the lens and rotor 113. The user's hand can also maintain a comfort gesture. The adjusting wheel 21 can be rotated for focusing to acquire images.

Referring to FIG. 3, when the first casing 11 and the second casing 12 are opened in V-shape, the second casing 12 can be placed on a table as a seat. At this time, the first casing 11 sideward stand over the second casing 12. The object to be shot can be put on an inner side of the second casing 12 (i.e. the side facing the first casing 11). The second casing 12 now becomes an object carrier. The object on the carrier can be shot by downward rotating the lens 2 to aim the object. The user can view the display 12 on the first casing 11 to detect the image shot.

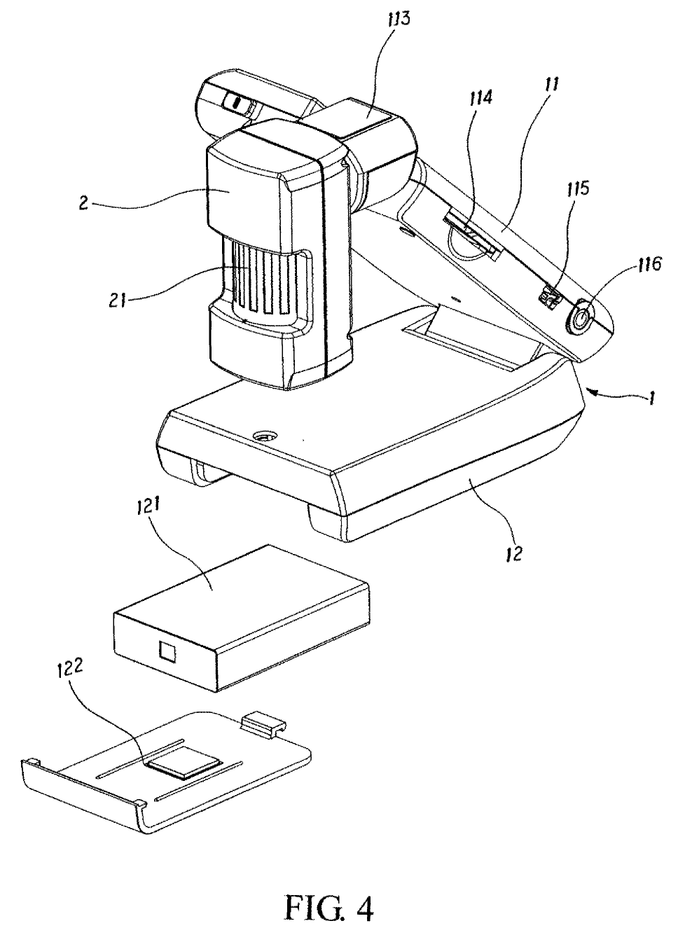

Preferredly, the first casing 11 can be provided with a card slot 114 for memory card so that the display 111 can show the pictures stored in the memory card. Also, the first casing 11 can be provided with a digital port 115 and an audio/video inserting hole 116 for connecting with an external device and accessing digital and analog signals. As shown in FIG. 4, a battery 121 is accommodated in the second casing 12 and covered by a battery cover 122. By the weight of battery 121, the second casing 12 can be stably placed on the table.

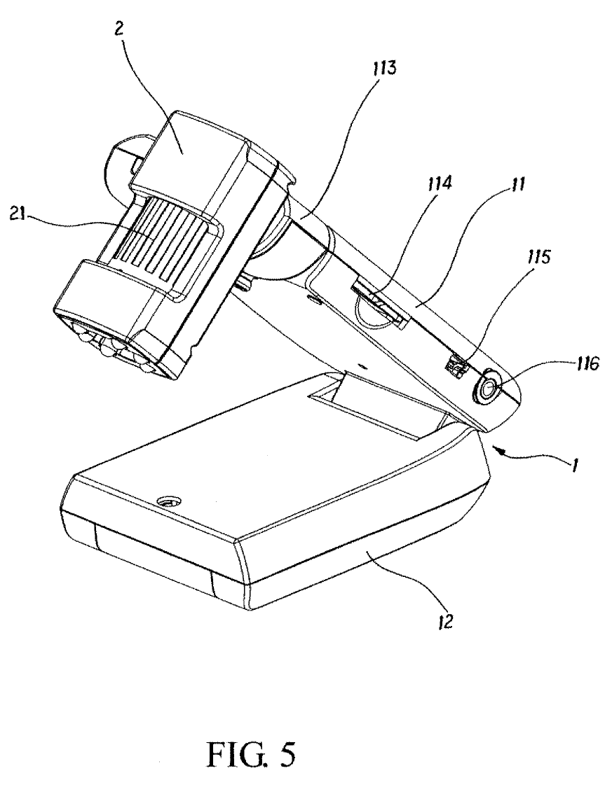

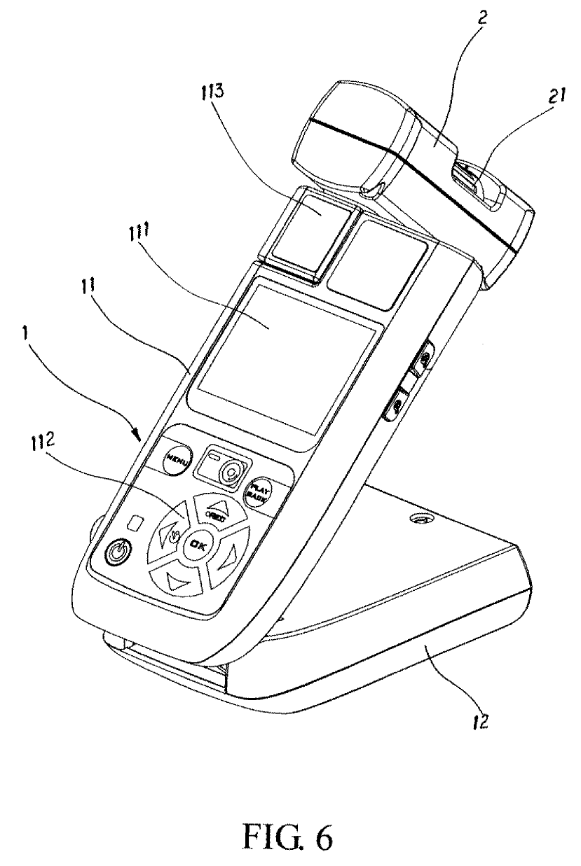

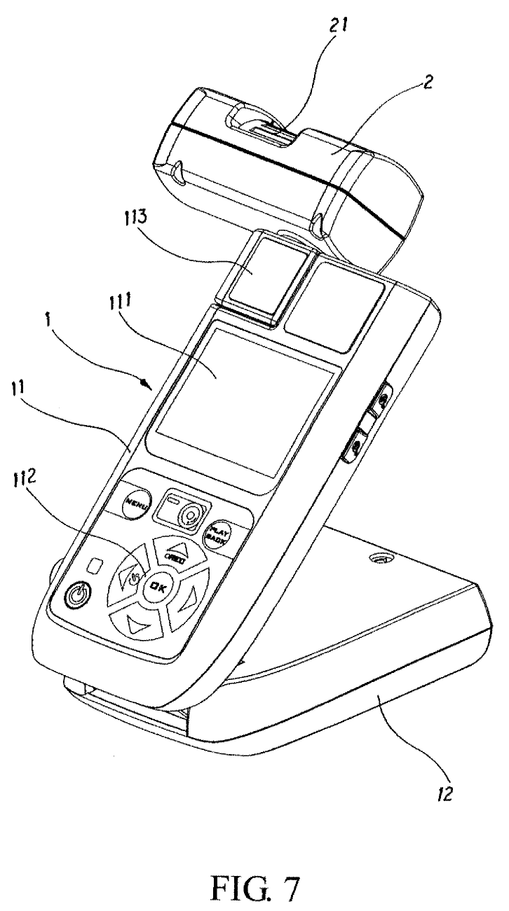

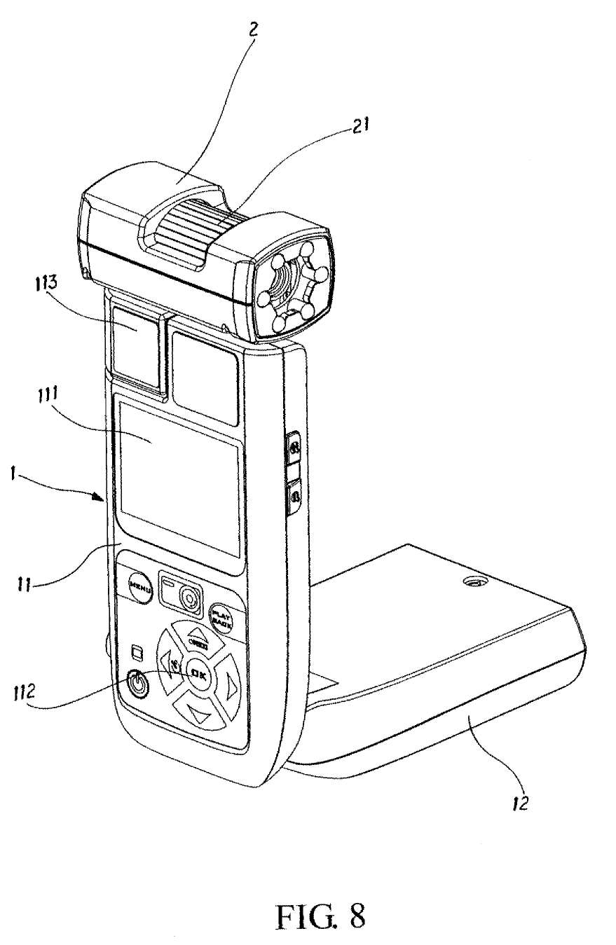

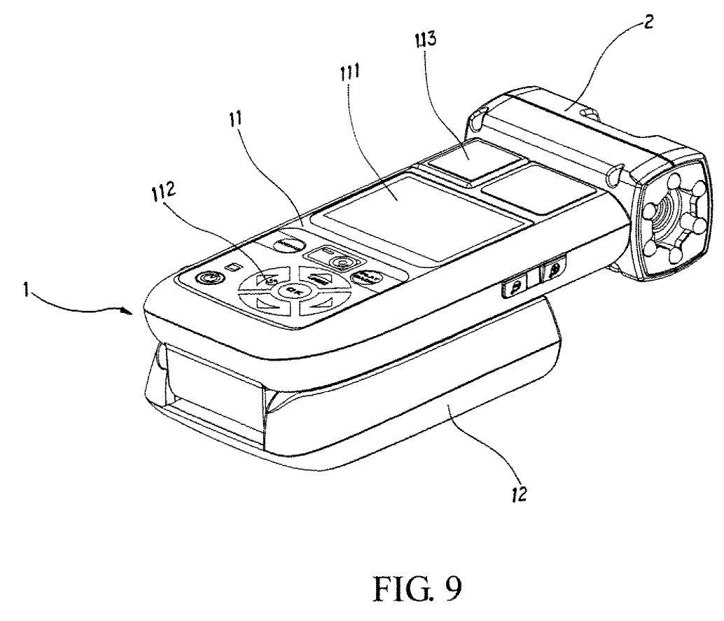

FIGS. 5-7 show the lens 2 turned to different angles when the body 1 is opened in V-shape. FIG. 8 shows the body 1 opened in 90 degree; and FIG. 9 shows the body 1 parallelly folded up.

What is claimed is:

1. An image acquisitioner with micro objective lens, comprising:
a body composed of a first casing and a second casing rotatably connected thereto to form a V-shape foldable configuration;
a rotor rotatably connected at an outer end of the first casing, being longitudinally rotatable in opposition to the first casing; and
a micro objective lens rotatably connected at an outer end of rotor, being transversely rotatable in opposition to the rotor.

2. The image acquisitioner with micro objective lens of claim 1, further comprising a display on the first casing.

3. The image acquisitioner with micro objective lens of claim 1, further comprising a keypad on the first casing.

4. The image acquisitioner with micro objective lens of claim 1, wherein a length of the lens is approximately the same as a width of the body.

5. The image acquisitioner with micro objective lens of claim 1, further comprising a battery accommodated in the second casing.

6. The image acquisitioner with micro objective lens of claim 1, wherein the lens is provided with an adjusting wheel for focusing.

7. The image acquisitioner with micro objective lens of claim 4, wherein the lens is provided with an adjusting wheel for focusing.

8. The image acquisitioner with micro objective lens of claim 1, wherein the lens is provided with an adjusting wheel for focusing.

9. The image acquisitioner with micro objective lens of claim 1, wherein the first casing is provided with a digital port for accessing digital signals.

10. The image acquisitioner with micro objective lens of claim 1, wherein the first casing is provided with an audio/video inserting hole for accessing analog signals.
